(19) United States
(12) Patent Application Publication
(10) Pub. No.: US 2011/0037655 A1
(43) Pub. Date: Feb. 17, 2011

(54) Dielectric-loaded and coupled planar antenna

(76) Inventors: Yueh-Lin Tsai, Shueilin Township (TW); Sheng-Kai Wen, Kaohsiung City (TW); Chih-Wei Chen, Houlong Township (TW); Po-Chun Huang, Taichung City (TW); Lee-Ting Hsieh, Yanpu Township (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 12/461,565

(22) Filed: Aug. 17, 2009

(51) Int. Cl. H01Q 1/38

(52) U.S. Cl. 343/700 MS

(57) ABSTRACT

A dielectric-loaded and coupled planar antenna includes a ground plane, a radiator, a ceramic substrate and at least one ground coupling electrode. The radiator is formed by extending one side of the ground plane, and a feeding point is formed between the radiator and the ground plane. The radiator extends at least one end portion on the ceramic substrate. The ground coupling electrode is formed on the ceramic substrate by extending the other side of the ground plane. The ground coupling electrode formed on the ceramic substrate and the end portion of the radiator formed on the ceramic substrate are coupled with each other to form a coupling electrode. The present invention can adjust the coupling amount loaded by the ceramic substrate so as to be operated in a desired frequency range. The present invention can be operated in a single-frequency, dual-frequency or multi-frequency condition.

### BACKGROUND OF THE INVENTION

1. Field of the Invention

The present invention relates to a dielectric-loaded and coupled planar antenna, and more particularly to a dielectric-loaded and coupled planar antenna which can use dielectric-loaded coupling electrodes to produce coupling effects.

2. Description of Related Art

Antenna efficacy is very important to wireless communication quality. Various antennae for wireless communication systems have different characteristic requirements according to different applications. For example, for carry and appearance, mobile phones for wireless communication may have in-built antennae with a single function or multi functions for mobile communication, location, digital televisions, wireless local networks and so on. Antennae disposed on base stations have various field type and polarization requirements according to difference circumstances surrounding positioned addresses. At present, industry focuses on reducing sizes of various mobile antennae and designing antennae with multi functions to reduce the number of antennae and save device costs.

However, for desired wireless communication functions, most of conventional electronic products need antennae with large sizes, so they must provide large clearance area in shells or on substrates in order that the antennae radiate signals. On the other hand, most of antennae can only be operated in a single frequency range and cannot be operated in multi frequency ranges.

Hence, the inventors of the present invention believe that the shortcomings described above are able to be improved and finally suggest the present invention which is of a reasonable design and is an effective improvement based on deep research and thought.

### SUMMARY OF THE INVENTION

A main object of the present invention is to provide a dielectric-loaded and coupled planar antenna which can use ceramic to load coupling electrodes and determine operating frequencies according to signal feeding positions and coupling amounts produced on a ceramic substrate, thereby achieving antenna characteristics of high efficiency and high frequency bandwidth.

To achieve the above-mentioned object, a dielectric-loaded and coupled planar antenna in accordance with the present invention is provided. The antenna includes a ground plane; a radiator formed by extending one side of the ground plane, wherein a feeding point is formed between the radiator and the ground plane; a ceramic substrate, on which the radiator extends at least one end portion; and at least one ground coupling electrode formed on the ceramic substrate by extending the other side of the ground plane, wherein the ground coupling electrode formed on the ceramic substrate and the end portion of the radiator formed on the ceramic substrate are coupled with each other to form a coupling electrode.

The present invention further provides a dual-frequency or multi-frequency dielectric-loaded and coupled planar antenna. The antenna includes a ground plane; a plurality of radiators formed by extending the ground plane, wherein a feeding point is formed between each radiator and the ground plane; a ceramic substrate, onto which each radiator has at least one end portion extending; and at least one ground coupling electrode which is formed on the ceramic substrate by extending the other side of the ground plane, wherein the ground coupling electrode formed on the ceramic substrate and the end portion of each radiator formed on the ceramic substrate are coupled with each other to form a coupling electrode.

The present invention has the efficacy as follows: the dielectric-loaded and coupled planar antenna of the present invention can adjust operating frequencies via adjusting the signal feeding positions and the loaded plane on the ceramic substrate, so it can be operated in a shell with a limited space and keep good antenna efficiency. Furthermore, the present invention can be used in dual-frequency or multi-frequency antennae to reduce the sizes and achieve good antenna characteristics.

To further understand features and technical contents of the present invention, please refer to the following detailed description and drawings related the present invention. However, the drawings are only to be used as references and explanations, not to limit the present invention.

### BRIEF DESCRIPTION OF THE DRAWINGS

FIG. 1 is a schematics view of a dielectric-loaded and coupled planar antenna of a first embodiment of the present invention;

FIG. 2 is an S11 simulation curve graph of the dielectric-loaded and coupled planar antenna of the first embodiment of the present invention;

FIG. 2A is a Smith Chart simulation graph of the dielectric-loaded and coupled planar antenna of the first embodiment of the present invention;

FIG. 3 is a schematics view of a dielectric-loaded and coupled planar antenna of a second embodiment of the present invention;

FIG. 4 is a schematics view of a dielectric-loaded and coupled planar antenna of a third embodiment of the present invention;

FIG. 5 is an S11 simulation curve graph of the dual-frequency dielectric-loaded and coupled planar antenna;

FIG. 5A is a Smith Chart simulation graph of the dual-frequency dielectric-loaded and coupled planar antenna;

FIG. 5B is an S21 simulation curve graph of the dual-frequency dielectric-loaded and coupled planar antenna;

FIG. 6 is a schematic view of different positions of feeding points of the dielectric-loaded and coupled planar antenna of the present invention;

FIGS. 6A-6B are schematic views of coupling electrodes of the dielectric-loaded and coupled planar antenna of the present invention, located on different planes; and

FIGS. 6C-6E are schematic views of coupling electrodes of the dielectric-loaded and coupled planar antenna of the present invention, in different-modes.

### DETAILED DESCRIPTION OF THE PREFERRED EMBODIMENTS

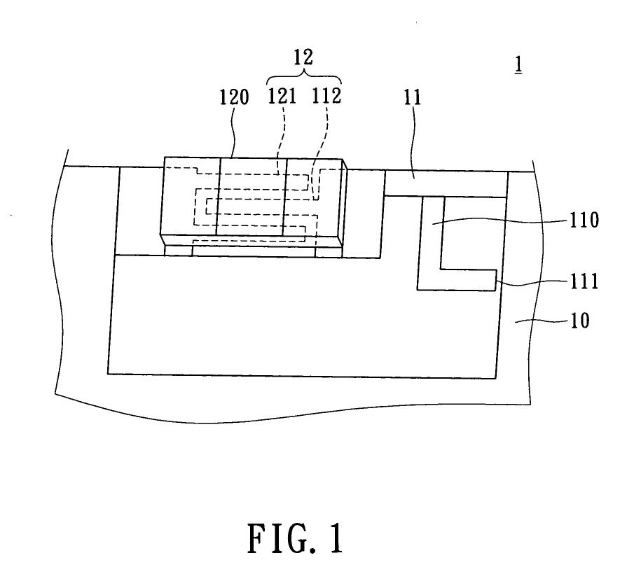

Please refer to FIG. 1 illustrating a dielectric-loaded and coupled planar antenna 1 according to the present invention which uses a dielectric-loaded coupling electrode to produce coupling effects based on the structure of PIFA antenna in order to reduce the size of the planar antenna and achieve the antenna characteristics of high efficiency and high frequency bandwidth. In structure, the dielectric-loaded and coupled planar antenna 1 is formed by a dielectric substrate for grounding the antenna and a ceramic sheet; however, in actual effects, the dielectric-loaded and coupled planar antenna 1 includes a ground plane 10, a radiator 11 and at least one coupling electrode 12 which is formed by one end portion 112 of the radiator 11 disposed on a ceramic substrate 120 and a ground coupling electrode 121 disposed on the ceramic substrate 120.

The radiator 11 is formed by extending one side of the ground plane 10, the other side of the ground plane 10 is extended to form the at least one ground coupling electrode 121, and a feeding point 111 is formed between the radiator 11 and the ground plane 10. Further, the radiator 11 has at least one en d portion 112 extending onto the ceramic substrate 120, the ground coupling electrode 121 are also formed on the ceramic substrate 120, and the end portion 112 of the radiator 11 and the ground coupling electrode 121 are coupled with each other to form the coupling electrode 12. In other words, the end portion 112 of the radiator 11 and the ground coupling electrode 121 produce coupling effects so that the present invention can adjust operating frequencies according to different coupling amounts.

Please refer to FIG. 1 again, illustrating a first embodiment of the dielectric-loaded and coupled planar antenna 1 of the present invention. In the first embodiment, the dielectric-loaded and coupled planar antenna 1 is a single-frequency antenna. The ground plane 10 extends from the right side end of the whole antenna to the left side end thereof to form a similar U-shaped structure, the radiator 11 is formed by extending the right side end of the ground plane 10, and the feeding point 111 is located at the right side end of the ground plane 10. On the other hand, the ground coupling electrode 121 is formed by extending the left side end of the ground plane 10, and the ground coupling electrode 121 and the end portion 112 of the radiator 11 are formed on the ceramic substrate 120 so that the end portion 112 of the radiator 11 and the ground coupling electrode 121 are coupled with each other to form the coupling electrode 12. Accordingly, the present invention can adjust the coupling amount of the coupling electrode 12 via using the ceramic substrate 120 to load the coupling electrode 12, so that the present invention can be operated in various frequency bands in the same antenna size.

Furthermore, the dielectric-loaded and coupled planar antenna 1 further includes a signal feeding path 110 which is extended from the feeding point 111 and bent to one side of the radiator 11.

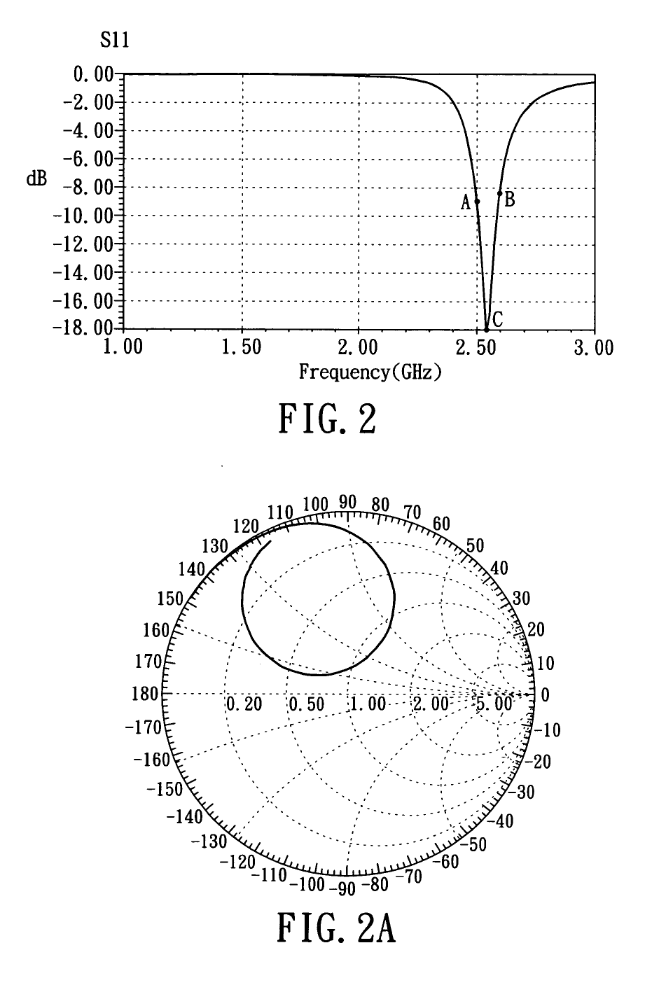

Please refer to FIG. 2 and FIG. 2A illustrating the simulation results of the dielectric-loaded and coupled planar antenna 1 of the first embodiment. FIG. 2 is the S11 simulation curve graph, wherein the measured data at A point is −9.1629 dB (the frequency is 2.50 GHz), the measured data at B point is −8.7710 dB (the frequency is 2.59 GHz), and the measured data at C point is −17.9411 dB (the frequency is 2.54 GHz). FIG. 2A is the Smith Chart of the dielectric-loaded and coupled planar antenna 1. According to the above-mentioned simulation data, the performance of the dielectric-loaded and coupled planar antenna 1 in the frequency range of 2.5 GHz can meet specification demands for common antennae.

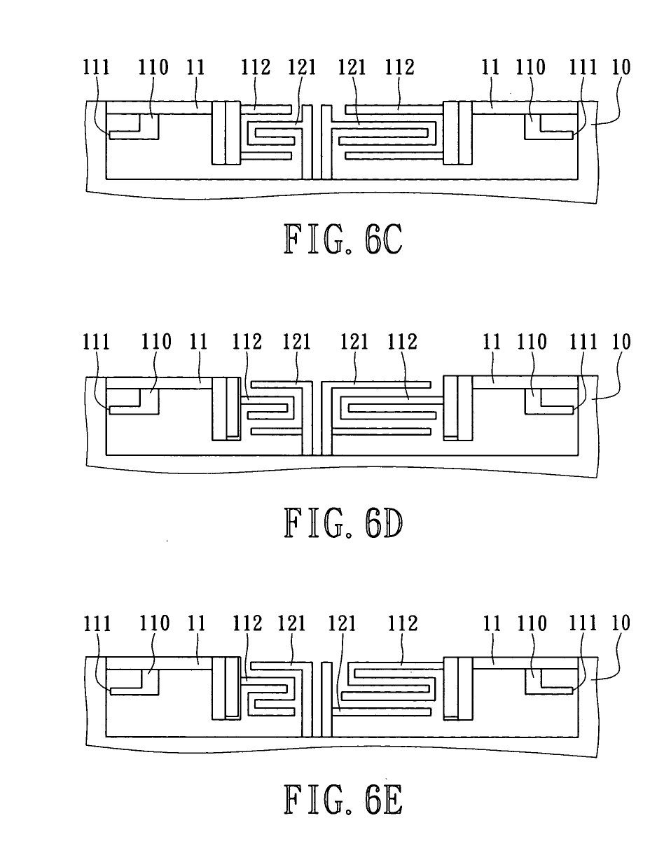

On the other hand, the dielectric-loaded and coupled planar antenna 1 of the first embodiment may have other changes. For example, the feeding point 111 may be located on a lower position and the signal feeding path 110 may be extended from the feeding point 111 and bent to the ground plane 10 (please refer to FIG. 6 in coordination). In other words, the position of the feeding point 111 may be adjusted based on actual applications.

Also, the number of the coupling electrodes 12 may be adjusted. To adjust the coupling amount according to the number of the coupling electrodes 12 is to determine the operating frequency of the dielectric-loaded and coupled planar antenna 1 so as to reach desired frequency range. For example, the number of the coupling electrodes 12 may be one or more than one.

In another aspect, the ceramic substrate 120 may be a single-layer or multi-layer ceramic body structure. In FIG. 1, the ceramic substrate 120 is a single-layer ceramic body structure, and the end portion 112 of the radiator 11 and the ground coupling electrode 121 which form the coupling electrode 12 are both formed on the lower surface of the ceramic substrate 120 (that is, they are formed on the same plane of the single-layer ceramic body structure). Alternatively, in another changed embodiment, the end portion 112 of the radiator 11 and the ground coupling electrode 121 are respectively formed on the upper surface and the lower surface of the ceramic substrate 120 (that is, they are formed on the different planes of the single-layer ceramic body structure), and please refer to FIG. 6A in coordination, the end portion 112 of the radiator 11 is formed on the upper surface of the ceramic substrate 120 and the ground coupling electrode 121 is located on the lower surface of the ceramic substrate 120. In other words, the ceramic substrate 120 is a multi-layer ceramic body structure, and the end portion 112 of the radiator 11 and the ground coupling electrode 121 are selectively formed on the upper surface, the lower surface or middle layers of the ceramic substrate 120.

Additionally, please refer to FIGS. 6C-6E in coordination, the ground coupling electrode 121 has various bent modes or is formed on the ceramic substrate 120 in a serpentine structure. Similarly, the end portion 112 of the radiator 11 may also be in a bent structure, a serpentine structure or other structures.

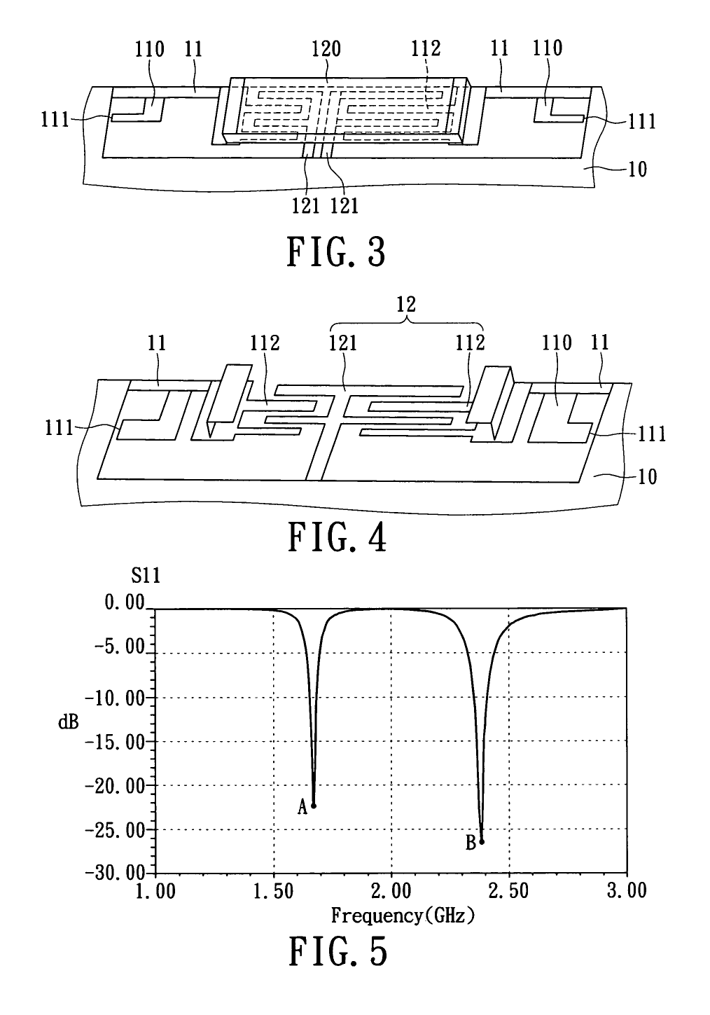

Please refer to FIG. 3 illustrating a dielectric-loaded and coupled planar antenna 1 of a second embodiment of the present invention. In the second embodiment, the dielectric-loaded and coupled planar antenna 1 is a kind of dual-frequency antenna; in other words, the present invention can be formed to be a dielectric-loaded and coupled dual-frequency or multi-frequency antenna based on the structure of the single-frequency antenna of the first embodiment. The dual-frequency dielectric-loaded and coupled planar antenna 1 of the second embodiment includes a ground plane 10, a ceramic substrate 120 and two radiators 11 formed by extending the ground plane 10. A feeding point 111 is formed between each radiator 11 and the ground plane 10, and each radiator 11 has an end portion 112 extending onto the ceramic substrate 120. Two ground coupling electrode 121 are extended from the ground plane 10 and formed on the ceramic substrate 120, and each of the ground coupling electrode 121 forms the coupling electrode 12 with the end portion 112 of the corresponding radiator 11. The coupling electrodes 12 located on the left side and the right side of the dielectric-loaded and coupled planar antenna 1 have different length, so the coupling amounts are different, thereby forming the dielectric-loaded dual-frequency antenna operated in two frequency ranges.

Furthermore, the dielectric-loaded and coupled planar antenna 1 further includes two signal feeding paths 110 each of which is respectively extended from the feeding point 111 of the corresponding radiator 11 and bent to one side of the radiator 11.

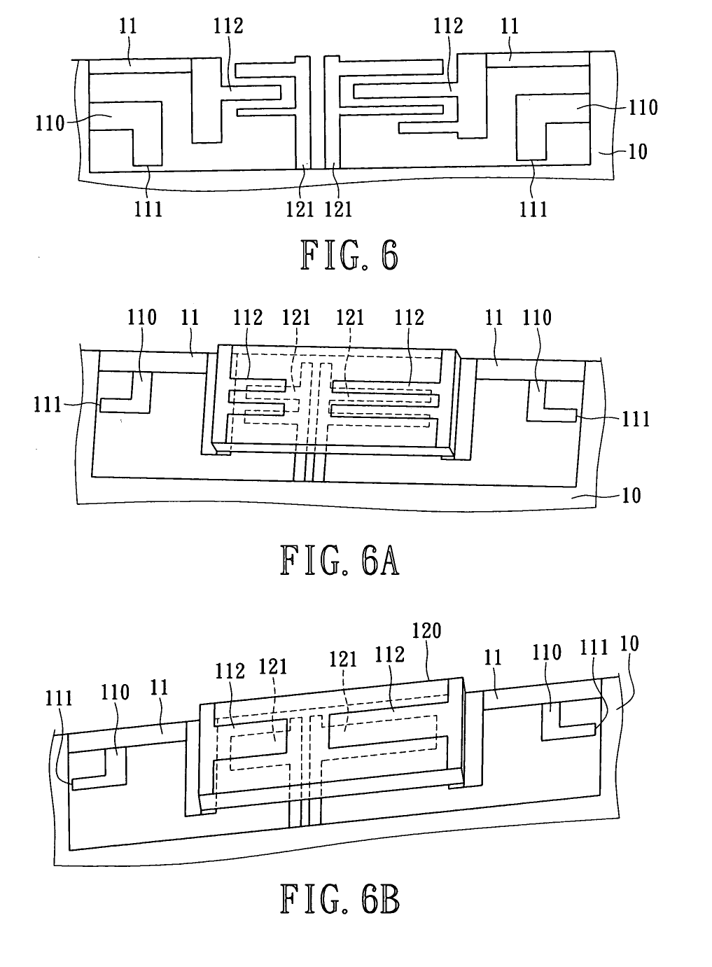

Please refer to FIG. 5 and FIG. 5B illustrating the simulation results of the dielectric-loaded and coupled planar antenna 1 of the second embodiment of the present invention. FIG. 5 is the S11 simulation curve graph, wherein the measured data at A point is −22.4299 dB (the frequency is 1.67 GHz), and the measured data at B point is −26.4225 dB (the frequency is 2.38 GHz). FIG. 5A is the Smith Chart of the dielectric-loaded and coupled planar antenna 1. FIG. 5B is the S21 simulation curve graph, wherein the measured data at A point is −25.7007 dB (the frequency is 1.67 GHz), the measured data at B point is −21.2301 dB (the frequency is 2.38 GHz), and the values on the S21 curve are all under −20 dB; in other words, the operations in the two frequency ranges have good isolation, that is, they don't interfere with each other. According to the above-mentioned simulation data, the performance of the dielectric-loaded and coupled planar antenna 1 can meet specification demands for dual-frequency antenna.

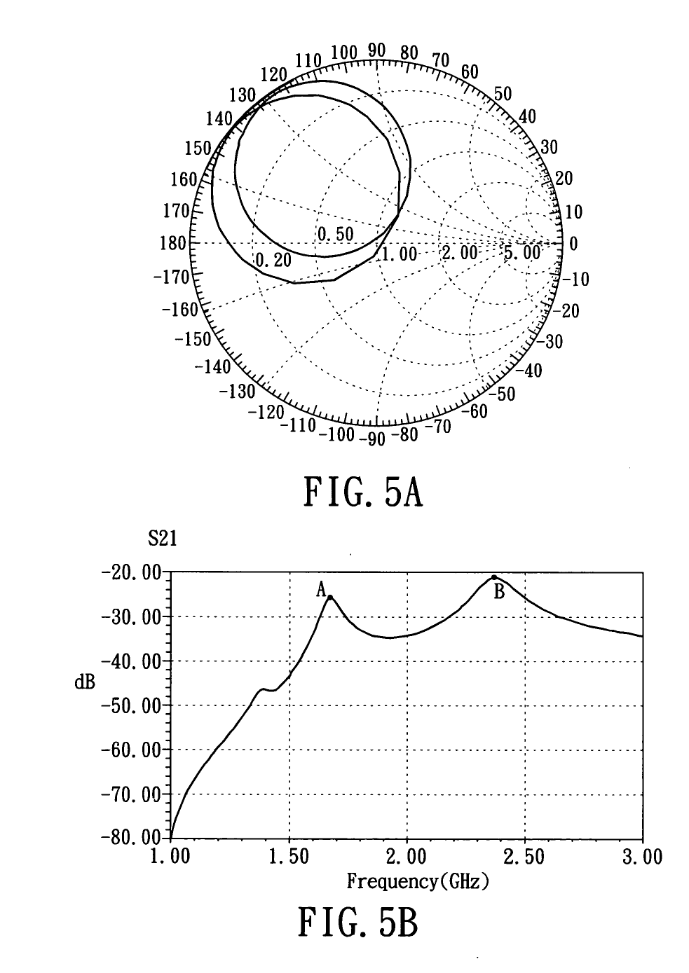

On the other hand, the dielectric-loaded and coupled planar antenna 1 of the second embodiment may have other changes. For example, the number of the coupling electrodes 12 may be adjusted, and as shown in FIG. 4 (the ceramic substrate 120 isn't shown in FIG. 4), there is only a single ground coupling electrode 121 extending from the ground plane 10, coupling branches are respectively extended from two sides of the ground coupling electrode 121 to form the coupling electrodes 12 with the end portions 112 of the corresponding radiators 11. FIGS. 6-6E show the changed modes of the second embodiment, for example, the ground coupling electrodes 121 and the end portions 112 of the radiators 11 are respectively formed on different planes of the ceramic substrate 120, etc. The description may refer to the related description for the first embodiment, which is omitted herein.

Accordingly, based on the dielectric-loaded and coupled planar antenna 1 for dual-frequency applications of the second embodiment, the present invention further provides a multi-frequency antenna which can extend a plurality of radiators 11 from the ground plane 10 and use the end portions 112 of the radiators 11 and the ground coupling electrodes 121 to form the coupling electrodes 12 located on the ceramic substrate 120. The multi-frequency antenna can be operated in multi frequency ranges via adjusting the coupling amounts of the coupling electrodes 12. Since the multi-frequency antenna has the same characteristics with the above-mentioned embodiments, the description is omitted herein.

Consequently, the present invention has the advantages as follows:
1. The present invention combines the antenna structure of PIFA with the ceramic loaded structure to produce coupling effects and determines operating frequency ranges according to the signal feeding positions and the coupling amounts produced by the coupling electrodes located on the ceramic substrate, thereby reducing the antenna size and achieving the antenna characteristics of high efficiency and high frequency bandwidth; and
2. On the other hand, the present invention can adjust the ceramic loaded coupling amounts to adjust the operating frequencies of the antenna, so the size of the antenna doesn't need to be increased, and the number of the coupling electrodes and the patterns of the coupling electrodes can be adjusted according to actual applications, so that signal interference is small when the present invention is operated in a multi-frequency condition, thereby achieving good antenna characteristics.

What are disclosed above are only the specification and the drawings of the preferred embodiments of the present invention and it is therefore not intended that the present invention be limited to the particular embodiments disclosed. It will be understood by those skilled in the art that various equivalent changes may be made depending on the specification and the drawings of the present invention without departing from the scope of the present invention.

What is claimed is:

1. A dielectric-loaded and coupled planar antenna, comprising:
a ground plane;
a radiator formed by extending one side of the ground plane, and a feeding point formed between the radiator and the ground plane;
a ceramic substrate, the radiator extending at least one end portion on the ceramic substrate; and
at least one ground coupling electrode, formed on the ceramic substrate by extending the other side of the ground plane, wherein the ground coupling electrode formed on the ceramic substrate and the end portion of the radiator formed on the ceramic substrate are coupled with each other to form a coupling electrode.

2. The dielectric-loaded and coupled planar antenna as claimed in claim 1, further comprising a signal feeding path extending from the feeding point to one side of the radiator.

3. The dielectric-loaded and coupled planar antenna as claimed in claim 1, further comprising a signal feeding path extending from the feeding point to the ground plane.

4. The dielectric-loaded and coupled planar antenna as claimed in claim 2, wherein the ceramic substrate has a single-layer or multi-layer ceramic body structure.

5. The dielectric-loaded and coupled planar antenna as claimed in claim 4, wherein the ground coupling electrode and the end portion of the radiator are formed on a same plane or different planes of the single-layer ceramic body structure.

6. The dielectric-loaded and coupled planar antenna as claimed in claim 5, wherein the ground coupling electrode and the end portion of the radiator are both formed on a lower surface of the single-layer ceramic body structure.

7. The dielectric-loaded and coupled planar antenna as claimed in claim 5, wherein one of the ground coupling electrode and the end portion of the radiator is formed on a lower surface of the single-layer ceramic body structure and the other is formed on an upper surface of the single-layer ceramic body structure.

8. The dielectric-loaded and coupled planar antenna as claimed in claim 4, wherein the ground coupling electrode and the end portion of the radiator are selectively formed on an upper surface, a lower surface or a middle surface of the multi-layer ceramic body structure.

9. The dielectric-loaded and coupled planar antenna as claimed in claim 4, wherein the ground coupling electrode has a multi-bend structure or a serpentine structure, which is formed on the ceramic substrate.

10. The dielectric-loaded and coupled planar antenna as claimed in claim 4, wherein the end portion of the radiator has a multi-bend structure or a serpentine structure, which is formed on the ceramic substrate.

11. A dielectric-loaded and coupled planar antenna, comprising:
a ground plane;
a plurality of radiators, formed by extending the ground plane, a feeding point formed between each radiator and the ground plane;
a ceramic substrate, each radiator having at least one end portion extending onto the ceramic substrate; and
at least one ground coupling electrode, formed on the ceramic substrate by extending the other side of the ground plane, wherein the ground coupling electrode formed on the ceramic substrate and the end portion of each radiator formed on the ceramic substrate are coupled with each other to form a coupling electrode.

12. The dielectric-loaded and coupled planar antenna as claimed in claim 11, further comprising a plurality of signal feeding paths each of which extends from the feeding point of each radiator to one side of the radiator.

13. The dielectric-loaded and coupled planar antenna as claimed in claim 11, further comprising a signal feeding path extending from the feeding points to the ground plane.

14. The dielectric-loaded and coupled planar antenna as claimed in claim 12, wherein the ceramic substrate has a single-layer or multi-layer ceramic body structure.

15. The dielectric-loaded and coupled planar antenna as claimed in claim 14, wherein the ground coupling electrode and the end portion of each radiator are formed on a same plane or different planes of the ceramic body structure.

16. The dielectric-loaded and coupled planar antenna as claimed in claim 14, wherein the ground coupling electrode has a multi-bend structure or a serpentine structure, which is formed on the ceramic substrate.

17. The dielectric-loaded and coupled planar antenna as claimed in claim 14, wherein the end portion of each radiator has a multi-bend structure or a serpentine structure, which is formed on the ceramic substrate.
